(19) United States
(12) Patent Application Publication
(10) Pub. No.: US 2006/0222152 A1
(43) Pub. Date: Oct. 5, 2006

(54) Incomplete call notification for video

(75) Inventors: Eran Elias, Even Yehuda (IL); Danny Zach, Kfar Neter (IL); Dror Bin, Harzella (IL)

Correspondence Address: SUGHRUE MION, PLLC, 2100 PENNSYLVANIA AVENUE, N.W., SUITE 800, WASHINGTON, DC, 20037, US

(73) Assignee: COMVERSE LTD.

(21) Appl. No.: 11/168,386

(22) Filed: Jun. 29, 2005

Related U.S. Application Data
(60) Provisional application No. 60/666,165, filed on Mar. 30, 2005.

(51) Int. Cl. H04M 11/00; H04M 1/64; H04M 3/42

(52) U.S. Cl. 379/88.13; 379/88.12; 379/202.01

(57) ABSTRACT

A method and apparatus for providing a telephone subscriber with data of incomplete video calls is presented. A determination unit detects an incomplete video call, possibly by receiving a signal from a telephone switch, by receiving a signal from a video mail system or by monitoring the operation of the network exchange switch. An interrogation unit then obtains call data which indicates the calling party, and may give further details of the missed video call. The data is stored in a format for forwarding to the called party, preferably as an MMS. If call data is provided for all call types (such as both voice and video), the determination unit may also determine that a given call is a video call based on a call type indicator.

### RELATIONSHIP TO EXISTING APPLICATIONS

The present application claims priority from U.S. provisional patent application No. 60/666,165, filed on Mar. 30, 2005, the contents of which are hereby incorporated by reference.

### FIELD AND BACKGROUND OF THE INVENTION

The present invention relates in general to notification of incomplete video calls and, more particularly, but not exclusively, to a method and apparatus for supporting notification to a called party regarding video calls made to him which for one reason or another he did not answer. The present invention further relates, for example, to notifying the calling party when the called party becomes available.

Third generation (3G) cellular networks provide subscribers with the ability to place video calls in addition to traditional voice calls. The popularity of video calls is increasing, along with the availability of handsets enabled to communicate by video. Video calls are also available over IP, and are expected to be available over wireline telephony in the near future.

At present there are two main groups of incomplete call notification systems which are applicable to video calls. The first of these, currently applying to mobile telephone systems, is video mail. In the wireless version the called telephone may be in one of three unavailable states, (1) busy, (2) not available on the network and (3) available but not answering. In all three states it is desirable to divert a caller to the mailbox.

However video mail suffers from a significant disadvantage, which is that video mail is not widely available to subscribers, and even where available the number of subscribers is relatively small. An additional disadvantage of the mailbox is that video messages require large amounts of storage. Thus video mail is generally provided as an extra service for which the user pays. Even those subscribers with video mail may miss a large number of calls, since few callers tend to leave a video message when their call is unanswered. It is estimated that only 20% of callers leave voice messages, and that the percentage of callers who leave video messages will be even less. If a video message is not left, the called party is unaware that a call was missed, since video mail systems do not notify the called party if the caller does not leave a message.

A second solution is caller ID. In the wireline environment a caller ID device extracts the caller line identification (CLI) information from an incoming call, possibly together with date and time information and displays the information on a screen. The device may be able to display a certain number of previous callers, and may be incorporated into a telephone or may be included in a stand-alone device. In the wireless environment, if a call reaches a mobile telephone then the caller ID details are generally available to the user, irrespective of whether the call was completed. If however the telephone is unreachable (for example, out of battery) at the time of the call, then the video mail facility is the only way that the user can know about the call.

Caller ID has been extended in the wireless environment to situations in which the mobile telephone is not connected at the time of the call. In such a case a network switch detects details of the incomplete call and sends those details as an SMS message to the mobile telephone. The message is then received the next time the user connects to the network and the user is notified of the missed call. However SMS notification provides only a limited text notification with the call details and is currently supported for voice calls only, not for video calls.

Nevertheless it is desirable to notify a user whenever possible of non-completed calls so that the user has the opportunity to return the call. From the point of view of the service provider, every non-completed call is a source of lost revenue and every opportunity to inform a user of the incomplete call is an opportunity to recover that revenue. Additionally, by identifying a missed call as a video call, the subscriber is encouraged to return a video call to the original caller, rather than a voice call.

There is thus a need for, and it would be highly advantageous to have, a way of notifying a user of incomplete video calls, and preferably for providing call details and devoid of the above limitations.

### SUMMARY OF EXMPLARY EMBODIMENTS OF THE INVENTION

According to a first exemplary embodiment of the present invention there is provided an incomplete call notification apparatus comprising a determination unit, an interrogation unit and a forwarding unit. The determination unit detects an incomplete video call. The interrogation unit obtains call data of the incomplete video call, the video call being to a given called party and the call data being at least indicative of a calling party. The forwarding unit arranges the called data into a format for forwarding to the called party.

According to a second exemplary embodiment of the present invention there is provided an incomplete call notification apparatus comprising: an input, a database, and a data provision unit. The input receives call data of an incomplete video call, the call data comprising at least caller identification information. The database stores at least the caller identification information from the input, and the data provision unit forwards the caller identification information to a called party.

According to a third exemplary embodiment of the present invention there is provided a method of providing sources of incomplete video calls comprising: setting at least one of a network exchange switch and a video mail system with a protocol for sending caller identification information of video calls made through the switch and not completed, the caller identification information being indicative of the source, receiving the caller identification information at a notification platform on the network, and forwarding the caller identification information to the respective called party.

According to a fourth exemplary embodiment of the present invention there is provided a method of providing sources of incomplete video calls comprising: setting at least one of a network exchange switch and a video mail system to provide a notification platform with a signal that a call has been placed through the switch, receiving the signal at a notification platform on the network, identifying the call as an incomplete video call, obtaining call data in response to the identification, the call data being at least indicative of a respective source, and arranging for forwarding of data indicative of the source to the respective called party.

According to a fifth exemplary embodiment of the present invention there is provided an incomplete call notification method comprising: detecting an incomplete video call, obtaining call data of the incomplete video call, the video call being to a given called party and the call data being at least indicative of a calling party, and arranging the called data into a format for forwarding to the called party.

Unless otherwise defined, all technical and scientific terms used herein have the same meaning as commonly understood by one of ordinary skill in the art to which this invention belongs. Although methods and materials similar or equivalent to those described herein can be used in the practice or testing of the present invention, suitable exemplary methods and materials are described below. In addition, the materials, methods, and examples are illustrative only and not intended to be limiting.

Implementation of the exemplary method and system of the present invention involves performing or completing selected tasks or steps manually, automatically, or a combination thereof. Moreover, according to actual instrumentation and equipment of preferred embodiments of the method and system of the present invention, several selected steps could be implemented by hardware or by software on any operating system of any firmware or a combination thereof. For example, as hardware, selected steps of the invention could be implemented as a chip or a circuit. As software, selected steps of the invention could be implemented as a plurality of software instructions being executed by a computer using any suitable operating system. In any case, selected steps of the method and system of the invention could be described as being performed by a data processor, such as a computing platform for executing a plurality of instructions.

### BRIEF DESCRIPTION OF THE DRAWINGS

The exemplary embodiments are herein described, by way of example only, with reference to the accompanying drawings. With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

In the drawings:

FIG. 1a is a simplified block diagram of an incomplete call notification apparatus, according to a first preferred embodiment of the present invention.

FIG. 1b shows a screen example of an MMS (multimedia messages service) missed call notification which contains a frame of the missed video call;

FIGS. 2a and 2b are part block and part flow diagrams illustrating examples of missed video call handling for a called party without and with video mail service respectively;

FIG. 3 is a flow chart illustrating a non-limiting example of missed call notification messaging.

FIG. 4a is a simplified block diagram of an incomplete call notification apparatus according to a second preferred embodiment of the present invention;

FIGS. 4b and 4c show screen examples of SMS missed call notification messages, in a non-aggregated and aggregated format respectively;

FIG. 5 is a simplified block diagram illustrating a typical video mail platform and call notification platform;

FIGS. 6a and 6b are simplified flow diagrams illustrating signal routing around the video mail plus call notification platform, in a mobile telephone environment, for a subscriber without and with video mail respectively;

FIG. 7 is a simplified flow chart of a method of providing sources of incomplete video calls, according to a first preferred embodiment of the present invention.

FIG. 8 is a simplified flow chart of a method of providing sources of incomplete video calls, according to a second preferred embodiment of the present invention.

FIG. 9 is a simplified flow chart detailing the operation of a network switch, according to a preferred embodiment of the present invention; and

FIG. 10 is a simplified flow chart detailing operation of the embodiment of the platform.

### DESCRIPTION OF THE PREFERRED EMBODIMENTS

The present embodiments show a method and apparatus for providing caller identification information following aborting of a video call, the formatting of the information into a missed call notification, and the provision of the missed call notification to a called party.

With the introduction of 3G cellular networks, video calls are becoming more and more common. Video calls are also available over IP, and are expected to be available over wireline telephony in the near future. Notifying video callers of incomplete calls (also denoted herein missed calls) is particularly important since video mail solutions are not prevalent and because it is expected that the rate of slam-downs (i.e. calls in which the caller disconnects without leaving a video message) will be high.

The present embodiments provide useful information, which would otherwise not be available, to the called party about missed calls. In the cellular environment, the present embodiments provide information about missed calls when the handset is turned-off, out of coverage, busy, or out of battery. It also provides information for slam-down situations, which would otherwise be unknown.

The principles and operation of an incomplete call notification apparatus for video calls may be better understood with reference to the drawings and accompanying descriptions.

Before explaining at least one exemplary embodiment of the invention in detail, it is to be understood that the invention is not limited in its application to the details of construction and the arrangement of the components set forth in the following description or illustrated in the drawings. The invention is capable of other embodiments or of being practiced or carried out in various ways. Also, it is to be understood that the phraseology and terminology employed herein is for the purpose of description and should not be regarded as limiting.

The following exemplary embodiments are directed at video calls placed over a cellular telephony system, preferably GSM, but apply to other telephony systems such as PSTN and video calls over IP, without limitation. In the following it is assumed that only subscribers with video-enabled telephones receive video calls, and that otherwise the video call is blocked at the network level.

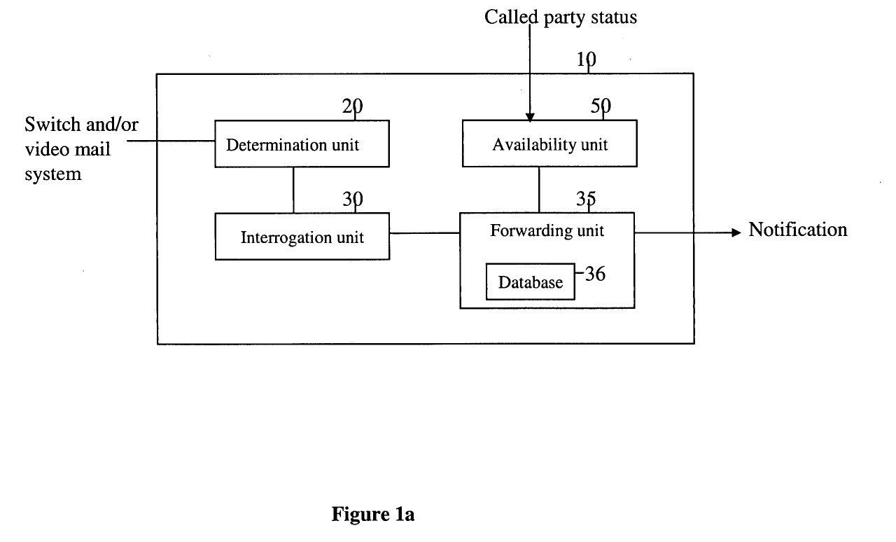

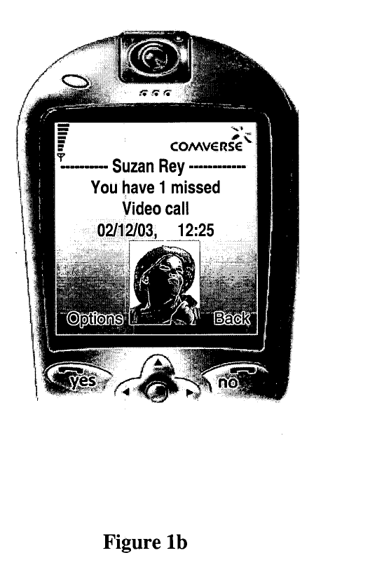

Reference is now made to FIG. 1a, which is a simplified block diagram of an incomplete call notification apparatus, according to a first preferred embodiment. Incomplete call notification apparatus 10 includes determination unit 20, interrogation unit 30, and forwarding unit 35. For clarity, incomplete call notification apparatus 10 is also denoted herein call notification apparatus.

Determination unit 20 performs missed call detection. The missed call may be due to a variety of reasons, including lost calls that result from slam-downs and from periods when a subscriber is unreachable. Unreachable status may include cases when the handset is turned off, out of battery, or out of coverage, and when the line is busy. In a wireless environment this can also include times when the handset is turned off, busy, or out of service range. When the called party subscribes to a video mail service, a call may be missed due to a slam-down or timeout.

Determination unit 20 may perform the detection in any manner known in the art, including, for example:
a. Receiving a signal from a telephone switch (such as an MSC)
b. Receiving a signal from a video mail system
c. Monitoring the operation of the switch (i.e. monitoring network traffic and signaling)
d. Monitoring the video mail system

Thus determination unit 20 is typically in communication with a telephone switch and/or video mail system. As is known to those skilled in the art, the switch typically connects a call to a called party, ensures that the telephone of the called party rings, and obtains information of the call such as the identity of the calling party. Generally the data that is available to the switch/video mail system includes the caller line identification (CLI). The switch tends to be aware of whether a call is completed or not since a non-completed call is not billed and may need to be rerouted to a video mail service if there is one. A time out function at the switch, for example, may disconnect a calling party after a certain time and reconnect the calling party to such a video mail facility.

In a preferred embodiment, when a call is not completed, the telephone switch indicates to determination unit 20 that a missed call occurred, and communicates call data (also denoted herein as missed call data), including the CLI and possibly other data such as the time of the call, to interrogation unit 30, either directly or via determination unit 20. In a first preferred embodiment, the indication that the call was missed and the call data may be bundled together in a single message, such as an ISUP IAM message. The IAM message is first processed by determination unit 20 to determine that the call was not completed. Determination unit 20 then passes the IAM message to interrogation unit 30 for extraction of caller information and any other information of interest. In a second preferred embodiment, determination unit 20 is provided with a signal that the call was missed, which triggers interrogation unit 30 to interrogate the telephone switch in order to obtain the call data.

In the preferred embodiment, when the called party is a video mail subscriber, the switch forwards the missed call to a video mail system. However, when the calling party is successfully transferred to the video mail, he may disconnect without leaving a message (slam-down). In these cases the video mail system identifies a missed call, and provides the information to the telephone switch (to forward to call notification apparatus 10) and/or directly to call notification apparatus 10.

In a further preferred embodiment, missed call detection is performed by monitoring a video mail system. In the preferred embodiment, one or more of the following techniques is used: measuring the amount of time that the diverted call spends in the video mail system, determining whether the caller hangs up before or after the tone for depositing a video mail, and monitoring the “New Voicemail” SMS message that is sent to the subscriber when a new video mail message has been deposited.

Typically the telephone switch automatically retains the information it has gathered about the last call information, such as the number of the calling party and the time at which the call was made. The last call information is generally not used in conventional systems and is later overwritten.

Call notification apparatus 10 obtains call data from the telephone switch and/or video mail system (typically including the CLI) as well as a call type indicator (which indicates if the given call is a video call) by communicating with the switch and/or video mail system according to a shared protocol. In the preferred embodiment, the call is placed over a mobile GSM telephone network, and the call type indicator is obtained from the ISUP IAM. The ISUP IAM preferably also supplies call data, including one or more of: redirection reason (RDR field), Calling Line Identity (CLI), and Originally Called Number (OCN).

The information regarding the missed call, including the call data and preferably the call type indicator, is transferred to forwarding unit 35, which arranges the call data into a format suitable for forwarding to the called party. The call type indicator indicates to forwarding unit 35 that the call notification should be arranged in the format suitable for video call notification. Missed call notification (also denoted herein the Who Called message or WHC) is sent by forwarding unit 35 to the called party. Forwarding unit 35 may transfer the missed call information to a delivery server, which delivers the missed call notification to the called party or makes the information otherwise available for to the called party. Preferably, forwarding unit 35 contains database 36 for storing the missed call information prior to sending it.

In the preferred embodiment, forwarding unit 35 formats the missed call notification for video calls as an MMS message. The MMS can provide the called party with more information than is providable by a SMS text message. Preferably the MMS contains a frame of the missed video call, as illustrated in FIG. 1b. Other message formats which take advantage of the graphical capabilities of MMS messaging are also possible, such as including an icon or graphic representing the caller or a picture which reminds the subscriber which handset button to push in order to return a video call (rather than a voice call).

In the preferred embodiment, missed call notification is provided by at least one of but not limited to:
a. MMS message
b. SMS message
c. Message posted on a specified web site
d. Email message to a specified email address, such as a telephone handset.
e. Multimedia or text messaging
f. Message retrieval by the subscriber, possibly as a vocal readout, via a telephone interface

In the following preferred embodiment, particularly suitable for wireless telephony, call notification is provided in a custom protocol to a call notification client installed on the subscriber's wireless device. Installing the call notification client also makes it possible to provide the subscriber with a simplified user interface, which is tailored to missed call notification.

Preferably, call notification apparatus 10 further includes availability unit 50 which identifies when the called party becomes available. The WHC message can then be provided to the subscriber. The availability information may also trigger a notification to the caller that the called party is now available (denoted herein a Notify Me message). The Notify Me message can be an SMS or MMS which includes a send button to redial the previously missed party, preferably as a video call In the preferred embodiment, availability unit 50 uses one or both of the following modes to enquire the reachability status of the called party.

1. Silent SMS mode—In GSM networks, the system can use a silent SMS message (referred to as “SMS Type 0” or “SMS0”), in order to receive a subscriber reachability alert. Availability unit 50 sends an SMS0 message to the SMSC. The SMSC sends the message to the subscriber, without the subscriber being aware of it. Once the subscriber becomes reachable, the SMSC notifies availability unit 50 of the SMS0 successful delivery, which serves as the trigger for the change of subscriber's status within call notification apparatus 10. As a result of the reachability status change, the call notification apparatus 10 retrieves the missed calls details from the database, and aggregates, formats and sends the missed call notification (and possibly the Notify Me message).

2. Push and Replace mode—This mode of operation utilizes the inherent retry- and-replace mechanisms of the SMSC and/or MMSC and does not require any reachability trigger. A new notification message is compiled upon every missed call event. The message is then sent to the SMSC and/or MMSC, using the inherent SMSC message replace mechanism. This mode of operation ensures that at any point in time, the most updated notification message is waiting in the SMSC and/or MMSC retry queue to be sent to the subscriber. When availability unit 50 determines that the subscriber is reachable again, the SMSC and/or MMSC sends the message stored in the queue. The successful delivery of the WHC message stored in the SMSC and/or MMSC queue, may serve as a trigger for sending the Notify Me message to the calling party.

Availability detection mechanisms are also discussed in U.S. Pat. Appl. No. 2004/0219908 of the present assignee, which is hereby incorporated by reference. These mechanisms can be utilized, for example, in the call notification apparatus 10 shown in FIG. 1.

Forwarding unit 35 preferably is preferably configurable by the operator and/or subscriber, to tailor the format of the Who Called message. Possible configuration options include aggregation type, the order in which messages are displayed, message header/body/footer format and content, maximum number of callers stored, length of time database retains missed call information, conditions for sending Notify Me messages, time periods for providing notifications, and so forth. Optionally, forwarding unit 35 may combine voice mail and video mail missed call notifications in a single Who Called message.

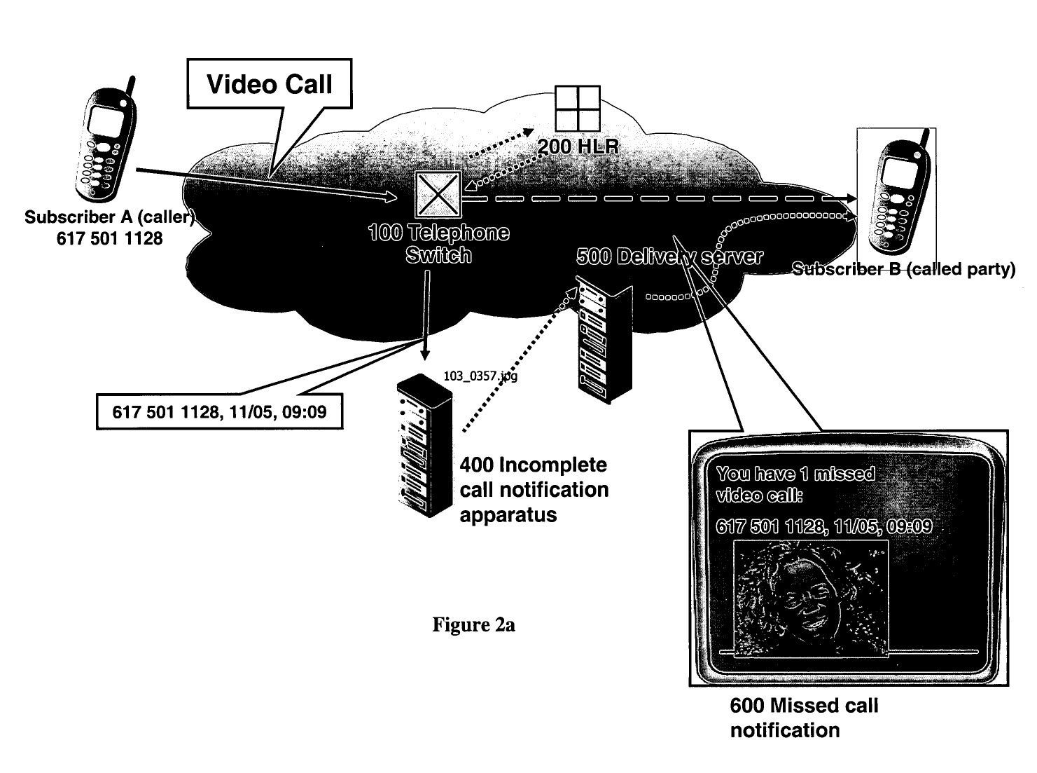

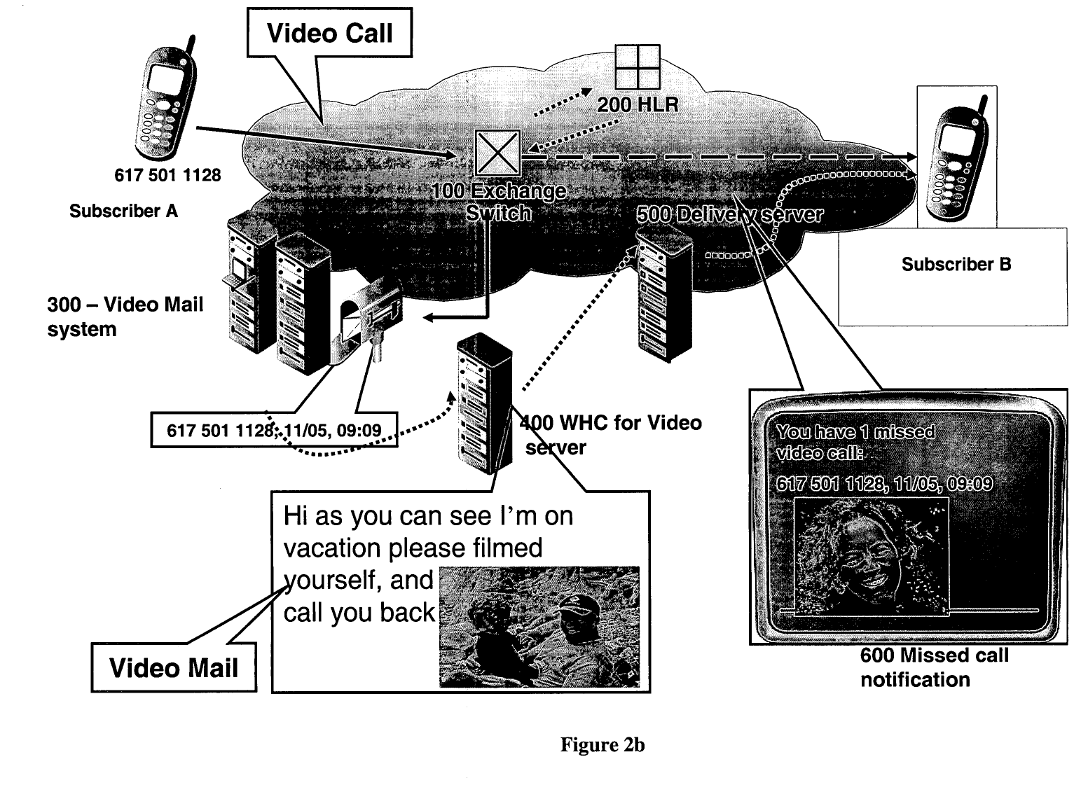

Reference is now made to FIG. 2a, which illustrates an example of missed video call handling for a called party without video mail service, for GSM cellular telephony. Analogous call handling is performable for wireline and video over IP calls. Subscriber A makes a video Call to subscriber B. Telephone switch (i.e. MSC) 100 diverts the call to HLR 200. The HLR 200 determines that subscriber B is unreachable, and commands telephone switch 100 to forward the call to incomplete call notification apparatus 400. Telephone switch 100 forwards the call to incomplete call notification apparatus 400, along with call data (such as the CLI, the destination number and the time of call) as well as a call type indicator identifying the call as a video call. Call notification apparatus 400 processes the call data information and forwards missed call notification 600 to subscriber B through delivery server 500.

Reference is now made to FIG. 2b, which illustrates an example of missed video call handling for a called party with video mail service for GSM cellular telephony. Analogous call handling is performable for wireline and video over IP calls.

Subscriber A makes a video Call to subscriber B. The telephone switch (MSC) 100 diverts the call to HLR 200. The HLR 200 determines that subscriber B is unreachable, and commands telephone switch 100 to forward the call to subscriber video mail system 300. Telephone switch 100 forwards the call to video mail system 300. In the case of a slam-down (i.e. subscriber A doesn't leave a message), the video mail system 300 sends the call data and call type indicator to call notification apparatus 400. Alternately or additionally, call notification apparatus 400 monitors the video call completion via probes mounted on the cellular operator's network, to determine information regarding slam-down, call type, etc. . . . to call notification apparatus 400. In the current case, the call data may also include a first screen shot of the caller which may be included in the notification provided to the called party, as described below. Call notification apparatus 400 processes the call data information and forwards the missed call notification 600 to subscriber B through delivery server 500.

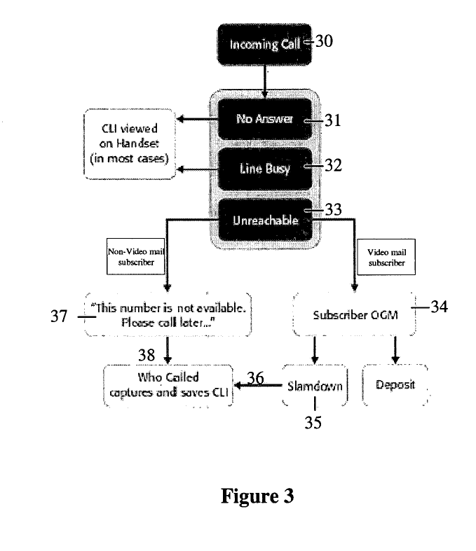

Reference is now made to FIG. 3, which illustrates a non-limiting example of missed call notification messaging. For subscribers with video mail service, when an incoming call 30 is not answered 31, busy 32, or the called party is unreachable for other reasons 33, the call is forwarded to the video mail system which plays the recorded message requesting that the caller leave a video message (OGM) 34. If the caller hangs up without depositing a message 35, the CLI is sent to the call notification apparatus by the video mail system 36. For subscribers without video mail service, a system message is played advising the caller that the called party is unavailable 37. The caller hangs up, without pressing special keys and does not leave a message, however the CLI is captured and provided to the call notification apparatus by the telephone switch 38. The caller may also be given an opportunity to waive a CLI restriction, so that their number can be reported to the called party.

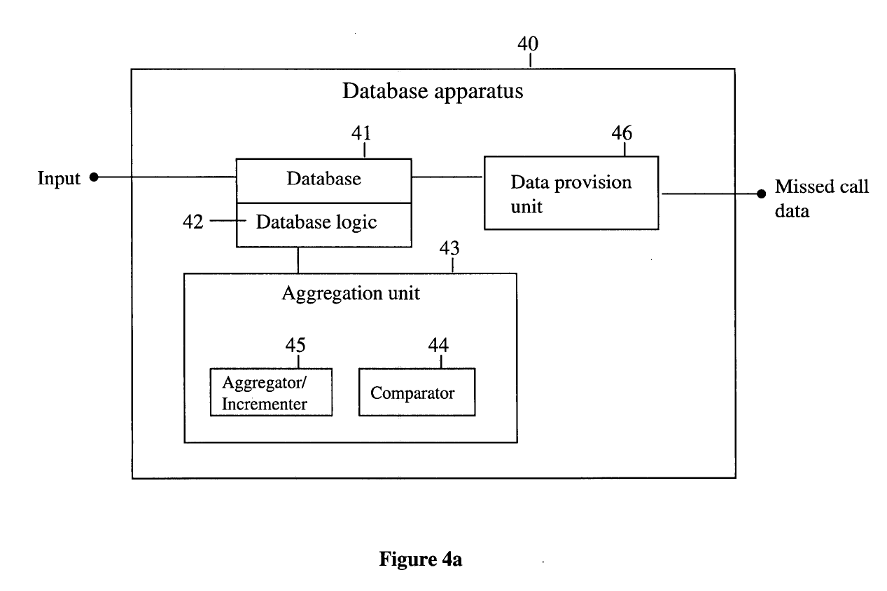

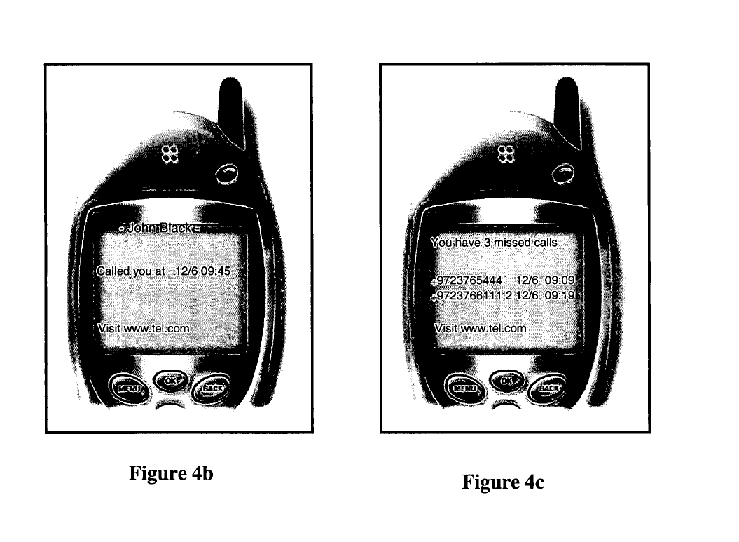

In an alternate preferred embodiment, the incomplete call notification apparatus contains a database apparatus which combines the functionality of the determination unit and the interrogation unit. Reference is now made to FIG. 4a, which is a simplified block diagram of call notification apparatus, according to a second preferred embodiment of the present invention. Call notification apparatus 40 contains a database 41 with an input for receiving call data for video calls, and a data provision unit 46, for providing the Who Called notification to the called party. Database 41 preferably contains a database logic 42 portion which communicates with the switch and/or video mail system to obtain information therefrom and manages data input, storage and output with database 41. Database logic 42 preferably has an incomplete call determination unit which determines that an incomplete call has occurred, preferably via the IAM message. The IAM message may additionally indicate the reason for the incomplete call and the call type (for determination that the call is a video call). Database 41 stores the call data used to provide missed call notification to the called party. Data provision unit 46 preferably incorporates one or more interfaces, such as MMS, SMS, messaging, email, Internet, or telephone (particularly for wireline telephones), for communicating the WHC message to the subscriber. It will be appreciated that since certain types of notifications, such as e-mail and messaging, can be sent out instantaneously, database 41 is not necessary in all applications.

Preferably, database apparatus 40 further includes aggregation unit 43 which has a comparator 44 and an aggregator 45. Comparator 44 preferably compares the number of a current calling party with numbers already stored in the database. If a match is found, aggregator 45 combines the current caller identification information with any already stored caller identification information into a single record, by updating the time of the call and incrementing a field to indicate how many calls have been received from the given calling party. Thus, if three calls have been received from a given number, the database will show one missed call notification entry showing that a call was missed from the given number three times. The data of the current call is not entered into the database as a separate entry because information corresponding to that call is already stored in the database, and it is desired to notify the called party only once for every CLI.

In an alternative embodiment, all call attempts are recorded as separate items in the database. Aggregation is performed only when the missed call notifications are provided to the called party. Aggregator 45 then scans the entries in the database and forms a single notification for each called party number, regardless of how many entries are stored in the database for the given number. Upon request, the user may be informed of the number of times the given number appears, rather than by a separate message for each occurrence of a call. For example, if a calling party calls four times, four separate records will be stored in the database. However, when the missed call notification is provided, aggregator 45 identifies that all four records pertain to a single caller, and generates a single missed call notification.

FIG. 4b shows an example of a non-aggregated SMS missed call notification message, while FIG. 4c shows an example of an aggregated SMS missed call notification message. Similar notifications, with and without aggregation, are applicable for MMS missed call notification.

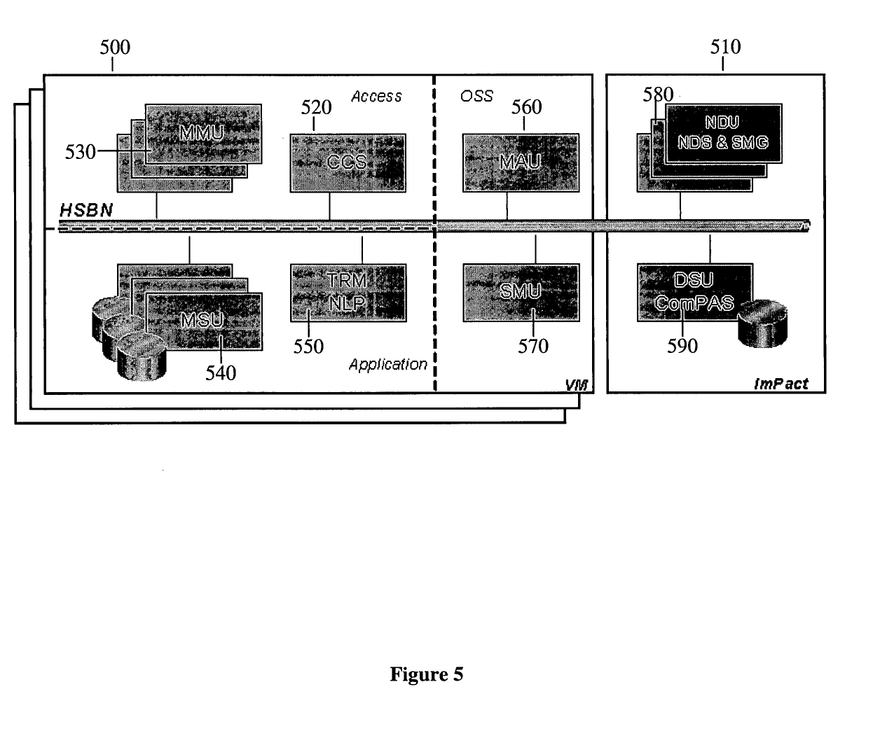

FIG. 5 is a simplified block diagram illustrating a typical video mail platform 500 and call notification platform 510, showing how video mail platform 500 may be adapted to incorporate an exemplary embodiment. Call notification platform 510 is based on the ImPact platform, provided by Comverse, Inc. 100 Quannapowitt parkway, Wakefield, Mass. 01880. The ImPact platform is presented on the Comverse, Inc. website (http://www.comverse.com/products/Impact.htm), which is hereby incorporated by reference. Video mail platform 500 is an exemplary embodiment of a video mail system. Other video mail platforms tend to incorporate the same overall functionality, albeit partitioned differently in terms of component blocks, and those skilled in the art will appreciate how the same principles can be applied to such other platforms. VM 500 includes the following components:

a call control server (CCS) 520, which handles the network signaling interaction for all the other components in VM platform 500;

a multimedia unit (MMU) 530 which provides a telephone interface for the messaging system as a whole and provides resources required for user interaction;

a messaging and storage unit (MSU) 540 is the application server for VM platform 500, handling video mail storage and retrieval;

a task and resource management (TRM) module 550 is the platform's management and control unit. It also hosts the Notification Layered Product (NLP), which serves as the VM gateway for outgoing notifications, and forwards slam-down events data to the call notification platform 510;

a management applications unit (MAU) 560 hosts administrative utilities such as remote access to the system; and

a system management unit (SMU) 570 is the primary monitoring point for SNMP-based management systems.

The call notification platform 510 includes the following components:

a notification delivery unit (NDU) 580 serves as a central notification platform and in particular hosts two applications: a notification delivery server (NDS) which handles notification logic and formats, and a smart mobile gateway (SMG), a logical component which interfaces with SMSC servers, MMSC servers, and Signaling servers (CCS); and

a database server unit (DSU) 590 collects details of all the calls made to a given subscriber, aggregates calls from the same calling party as described above and takes responsibility for notifying the called party. The DSU 50 encapsulates database 41 (DB) as well as database logic 42 as described for FIG. 4 hereinabove.

The components of both VM 500 and call notification platform 510 are connected as a local area network (LAN) via a data cable denoted the High Speed Backbone Network (HSBN).

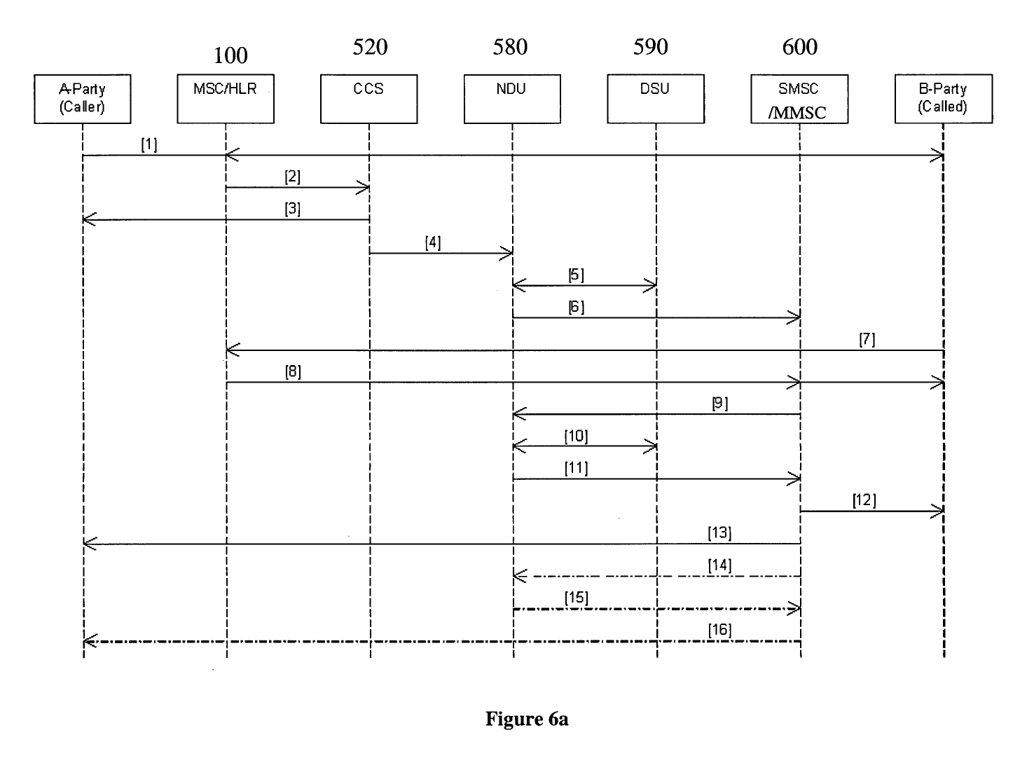

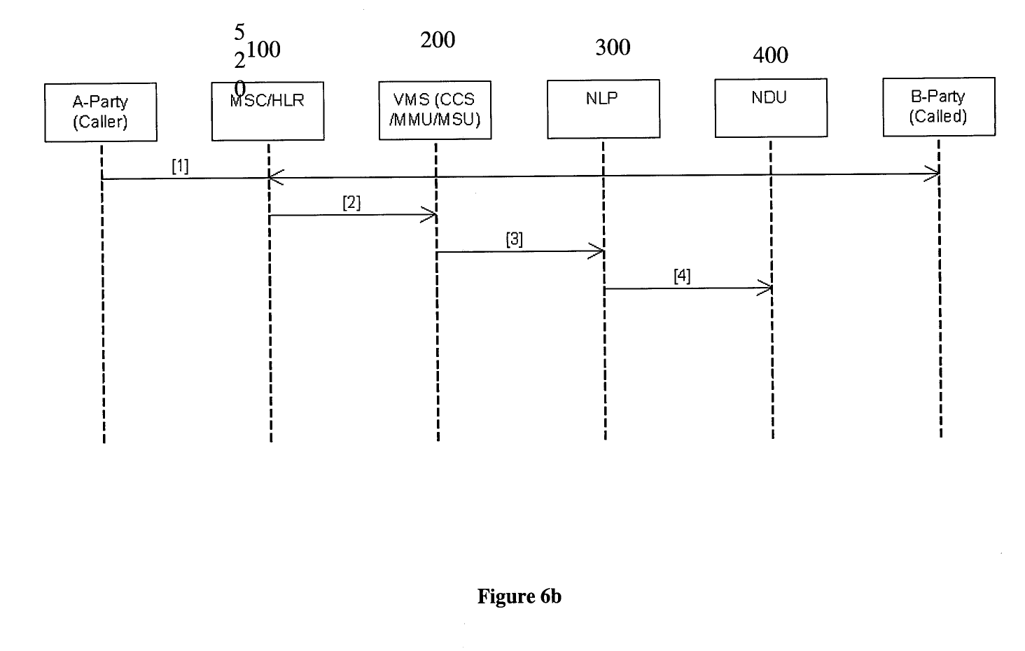

FIGS. 6a and 6b are simplified diagrams illustrating signal routing around the abovedescribed video mail plus call notification platform, in the GSM mobile telephone environment. FIG. 6a illustrates the case where the called party is not a video mail subscriber, while FIG. 6b illustrates the case where the called party is a video mail subscriber.

FIG. 6a shows the messaging that take place when the video call is not answered and the called party does not have video mail. Specifically, FIG. 6a shows the messaging operations [1] through [16]. Each of these messaging operations is described below:
[1] Subscriber A (caller) calls subscriber B (called party). The call is not answered.
[2] The MSC 100 (i.e. telephone switch) queries the HLR, and forwards the call to the CCS 520 according to the call forwarding settings.
[3] The CCS 520 (serving as a determination unit plus interrogation unit) recognizes the missed call event according to the forwarded-to number (FTN) and redirection reason (RDR) fields in the ISUP IAM message. The CCS extracts the call type indicator from the IAM message, and determines that the call is a video call. The CCS then extracts the Calling Line Identity (CLI) and Originally Called Number (OCN) from the IAM message and immediately releases the call, using ISUP REL message. The release cause value is set according to the operator requirements, in order to enable the MSC 100 to play the standard unreachable prompt or tone.
[4] The CCS 520 sends the missed call data (CLI, OCN, DN and RDR) to the NDU 580.
[5] The NDU 580 stores the missed call details in the DSU 590 (serving as the database plus database logic).
[6] The NDU 580 (serving as the forwarding unit) takes one of the following steps to determine when the subscriber becomes available, according to the called party reachability enquiry mode:
a. In silent SMS mode, if this is the first missed call to B, an SMS0 message for B is sent to the SMSC 600
b. In Push and Replace mode, an updated message of missed calls to B (retrieved from the DSU 590) is sent to the SMSC 600, replacing any pending missed calls message that might has been sent before.

The following steps take place when the called party becomes reachable again:
[7] Subscriber B becomes available. The mobile network receives this change of status.

[8] The HLR 100 updates the MMSC/SMSC 600 with the fact that subscriber B became available. The MMSC/SMSC 600 sends the stored message to subscriber B.

The following steps take place in silent SMS mode only:
[9] The SMSC 600 notifies the NDU 580 of the change in subscriber B reachability status by successful delivery of the SMS0 message.
[10] The NDU 580 retrieves the missed calls log from the DSU 590.
[11] The NDU 580 creates the Who Called message (i.e. missed call notification), and optionally a Notify Me messages informing subscriber A that subscriber B is now available, and sends them to the MMSC/SMSC 600 and clears the subscriber B missed calls log.
[12] The MMSC/SMSC 600 sends the Who Called message to subscriber B.
[13] The MMSC/SMSC 600 sends the Notify Me message to subscriber A.

The following steps take place in Push and Replace mode only:
[14] The SMSC 600 reports delivery success.
[15] The NDU 580 clears the subscriber B missed calls log and sends the Who Called message to the MMSC/SMSC 600.
[16] The MMSC/SMSC 600 sends the Notify Me message to subscriber A.

FIG. 6b shows the messaging operations that take place when the video call is not answered and the call is forwarded to the VM. Each of these messaging operations is described below:
[1] Subscriber A (caller) calls subscriber B (called party). The call is not answered.
[2] The MSC 600 queries the HLR, and forwards the call to the VM according to the call forwarding settings. Subscriber A hangs up the call before a message is deposited (slam-down).
[3] Upon slam-down event, the MSU 200 forwards the call details to the NLP 300.
[4] The NLP 300 forwards the call details to the NDU 400.
   From this point onwards, operations 5 to 16 shown in FIG. 6a and described above apply.

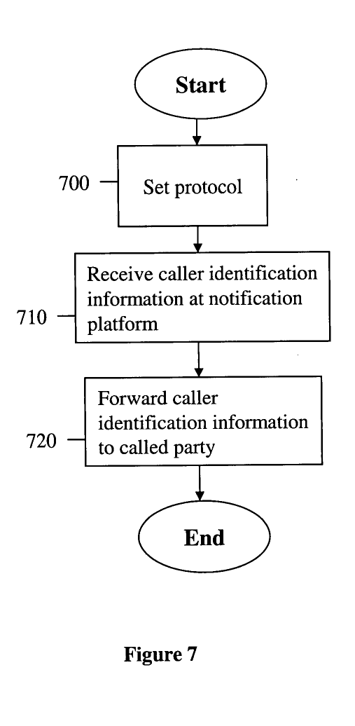

Reference is now made to FIG. 7, which is a simplified flow chart of a method of providing sources of incomplete video calls, according to a first preferred embodiment of the present invention. In operation 700 a network exchange switch and/or a video mail system is set with a protocol for sending caller identification information of incomplete video calls made through the switch. It may not be necessary to establish a custom protocol, but rather to adapt an existing protocol such as ISUP SS7 (as shown in FIGS. 6a and 6b). In operation 710, the caller identification information is received at a notification platform on the network, and in operation 720 the caller identification information is forwarded by the notification platform to the respective called party.

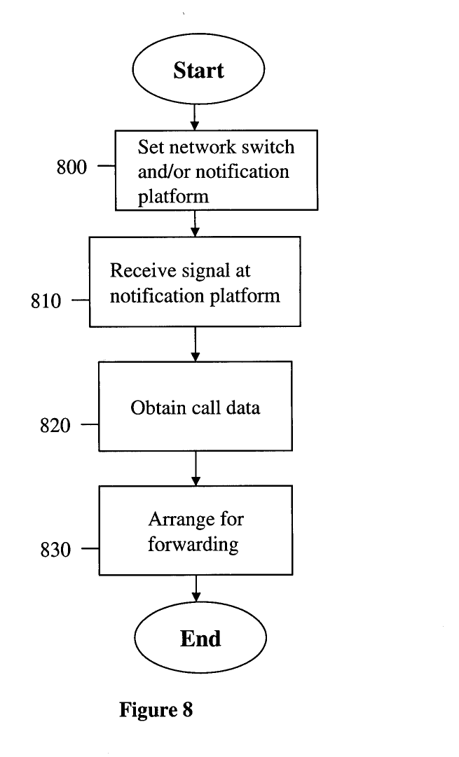

Reference is now made to FIG. 8, which is a simplified flow chart of a method of providing sources of incomplete video calls, according to a second preferred embodiment. In operation 800, a network exchange switch and/or a video mail system is set to provide a notification platform with a signal that a call has been placed through the switch. The signal may be sent only for incomplete calls, in which case the notification platform processes every such call as a missed call. Alternately, a signal is sent for both complete and incomplete calls, but the signal includes information which is used by the notification platform to identify missed calls. In operation 810, the signal is received at the notification platform on the network. In operation 820, the call is identified as an incomplete video call. In operation 830, call data is obtained in response to the identification of the call as an incomplete video call, preferably by querying the switch to provide stored call data or by extracting the call data from an ISUP IAM message. In operation 840, the forwarding of data, indicative of the caller, to the respective called party is arranged.

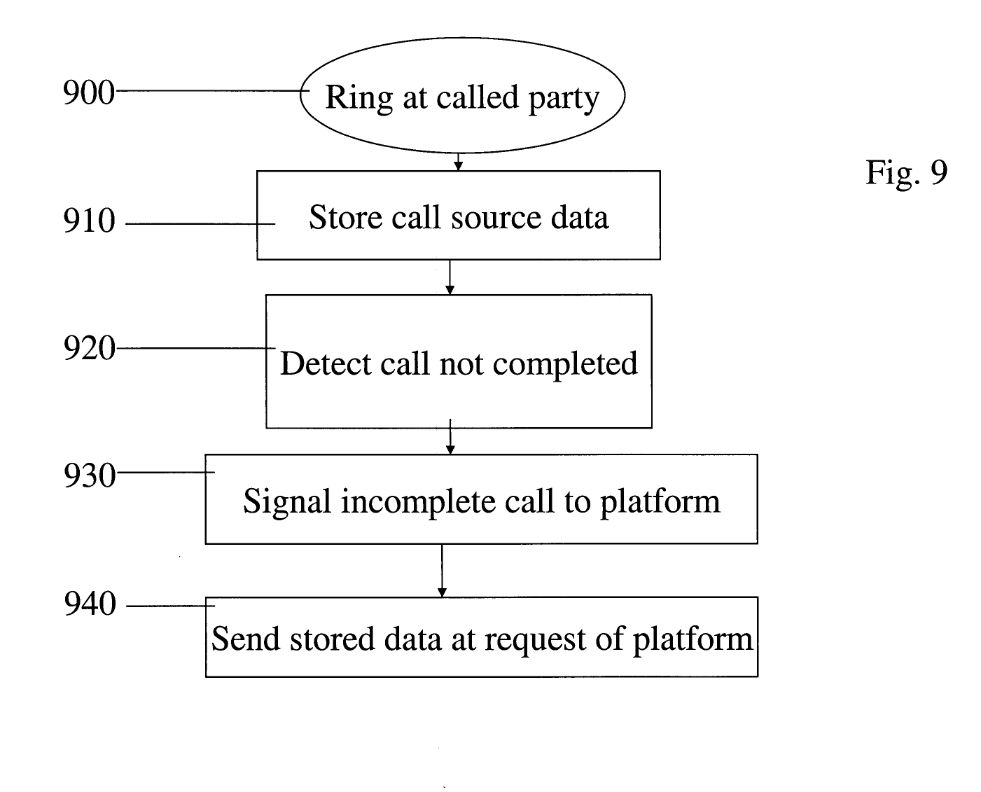

Reference is now made to FIG. 9, which is a simplified flow chart detailing the operation of a network switch, according to a preferred embodiment. FIG. 9 presents the case in which the network switch first signals the notification platform that an incomplete call has been detected, and provides the call data later in response to interrogation by the notification platform. In operation 900 the switch connects a call to a called party. In operation 900, the telephone rings at the called party, unless of course the telephone is busy, in which case a busy signal is received. Either way the call data, typically the CLI of the calling party is stored at the switch in operation 910. If the call is not completed, the switch detects non-completion in operation 920. A signal is then output to the notification platform in operation 930 to indicate non-completion of the call. In operation 940 the switch receives a signal from the platform in response to which it sends the call data stored in operation 910 to the platform.

In an alternate embodiment, upon detection of call non-completion the network switch forwards the call to a video mail system. If the video mail system detects a timeout or slam-down, it is the video mail system which sends the call data to the notification platform.

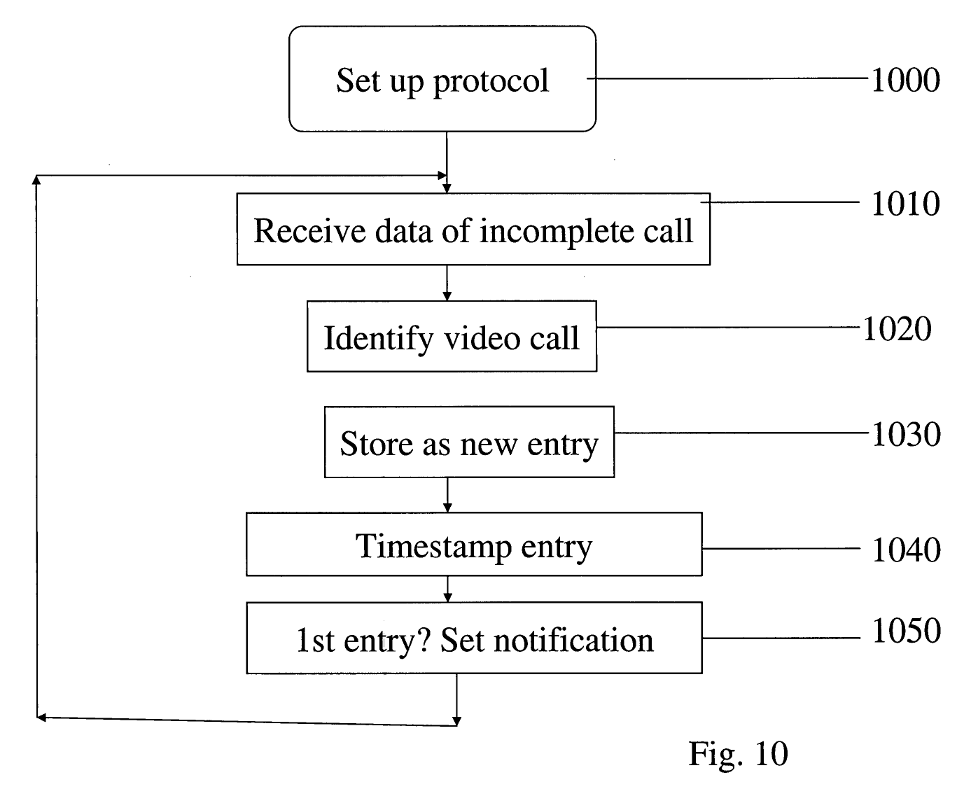

Reference is now made to FIG. 10, which is a simplified flow chart detailing operation of the embodiment of the platform. In the embodiment of FIG. 9, the platform sets up a protocol link with the switch (or video mail system) in a stage 1000. Setting up the protocol link may involve a standard protocol (such as ISUP SS7) or may require minor reprogramming to the switch, depending on the model of switch being used.

Once the protocol link has been set up, a monitoring process for incomplete calls may begin. In operation 1010, the platform receives a signal to indicate that an incomplete call has been detected. If the signal does not include call data, the switch is queried to obtain the call data. In operation 1020, the platform determines that the missed call is a video call. Preferably the platform checks whether the called party who is the object of the detected call is a subscriber for which it keeps missed call records, and if so the call is stored as a new entry in the database record for that subscriber in operation 1030. The entry is timestamped at operation 1040, and if the entry is a first new record for the given subscriber then in operation 1050 a notification may be set to alert the subscriber to the presence of incomplete call data. Alternately, subscriber availability is monitored, and an MMS or SMS is sent when the subscriber becomes available.

U.S. application Ser. No. 10/670,726 of the present assignee for missed call notification for voice calls is hereby incorporated by reference. In U.S. application Ser. No. 10/670,726, when an uncompleted call is detected, the telephony switch is interrogated to provide the call details. The call data is then stored in a format for forwarding to the called party. The present embodiments provide missed call notification to video calls, by tailoring the methods for determining that a call has been missed and for obtaining the missed call data for storage to video calls.

The above-described missed call notification system and method extend the currently available mechanisms for informing subscribers missed video calls. The power and flexibility of missed call notification extends far beyond the video mailbox. Missed call notification recovers “lost calls” that result from slam-downs and from periods when a subscriber is unreachable. Unreachable status can include cases when the phone is out of coverage, the line is busy, or call waiting status. In a wireless environment this can also include times when the handset is turned off or out of service range. Missed call notification extends the operator's regular Caller ID service by recording and reporting this lost information.

When the subscriber returns to available status, missed call notification provides the subscriber with a message listing all the calls that were missed. The form of the notification varies depending on the type of network and whether or not the user is a video mail subscriber. In any case, subscribers receive information about missed calls of which they were previously unaware.

Missed call notification is also beneficial for network operators. It is estimated that up to 15% of voice calls entering the operator's network are unanswered and lost because they are not diverted to subscribers mailbox and not tracked by a handset, and it is expected that the percentage will be significantly higher for video calls. Missed call notification encourages subscribers to return new video calls on the operator's network, thus increasing operator revenues.

It is expected that during the life of this patent many relevant forms of video calling, video mail systems, messaging protocols, network switch and exchange and protocols for using the same, and wireline and wireless telephones will be developed and the scope of these and other terms in this disclosure is intended to include all such new technologies a priori.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims. All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention.

What is claimed is:

1. Incomplete call notification apparatus comprising:
a determination unit for detecting an incomplete video call,
an interrogation unit associated with said determination unit, for obtaining call data of said incomplete video call, said video call being to a given called party and said call data being at least indicative of a calling party, and
a forwarding unit associated with said interrogation unit, for arranging said called data into a format for forwarding to said called party.

2. Incomplete call notification apparatus according to claim 1, wherein said determination unit is further operable to obtain a call type indicator identifying a call as a video call.

3. Incomplete call notification apparatus according to claim 2, wherein said call type indicator is extracted from an ISUP IAM message.

4. Incomplete call notification apparatus according to claim 2, wherein said forwarding unit is operable to arrange said called data in accordance with said call type indicator.

5. Incomplete call notification apparatus according to claim 1, wherein said call data is extracted from an ISUP IAM message.

6. Incomplete call notification apparatus according to claim 1, wherein said determining unit detects an incomplete video call by at least one of receiving a signal from a telephone switch, monitoring operation of said switch, and receiving a signal from a video mail system.

7. Incomplete call notification apparatus according to claim 1, wherein said interrogating unit obtains call data from at least one of a telephone switch and a video mail system.

8. Incomplete call notification apparatus according to claim 1, wherein said forwarding unit comprises a database for storing said call data.

9. Incomplete call notification apparatus according to claim 1, wherein said forwarding unit is operable for sending said data as an e-mail to a predetermined e-mail address.

10. Incomplete call notification apparatus according to claim 1, wherein said forwarding unit is operable for sending said data as a multimedia message to a predetermined messaging destination.

11. Incomplete call notification apparatus according to claim 2, wherein said video call is placed over a cellular telephone network.

12. Incomplete call notification apparatus according to claim 11, wherein said cellular telephony network comprises a GSM network.

13. Incomplete call notification apparatus according to claim 11, wherein said cellular telephony network comprises a Code Division Multiple Access (CDMA) network.

14. Incomplete call notification apparatus according to claim 11, wherein said forwarding unit is operable for sending said data as an SMS.

15. Incomplete call notification apparatus according to claim 11, wherein said forwarding unit is operable for sending said data as an MMS.

16. Incomplete call notification apparatus according to claim 15, wherein said MMS includes a frame of said video call.

17. Incomplete call notification apparatus according to claim 15, wherein said MMS includes a graphic image.

18. Incomplete call notification apparatus according to claim 1, wherein said video call is placed over a wireline telephone network.

19. Incomplete call notification apparatus according to claim 1, wherein said video call is placed over an IP network.

20. Incomplete call notification apparatus according to claim 1, wherein said forwarding unit is operable for posting said call data at a predetermined web site.

21. Incomplete call notification apparatus according to claim 8, wherein said database is associated with an aggregation unit comprising:
a comparator for comparing said obtained call data with call data stored in said database, and
an aggregator, associated with said comparator, for aggregating together said obtained call data with stored call data identified by said comparator, thereby to output said obtained and already stored called data together as a single item.

22. Incomplete call notification apparatus according to claim 8, wherein said database is associated with an aggregation unit comprising:
a comparator for comparing current call data with call data stored in said database, and
an aggregator, associated with said comparator, for storing said current call data together with any already stored call data identified by said comparator.

23. Incomplete call notification apparatus according to claim 1, wherein said call data comprises caller line identification (CLI).

24. Incomplete call notification apparatus according to claim 1, further comprising an availability unit for identifying when said called party becomes reachable.

25. Incomplete call notification apparatus according to claim 24, wherein said forwarding unit is further operable to notify a calling party when said called party becomes reachable.

26. Incomplete call notification apparatus comprising:
an input for receiving call data of an incomplete video call, said call data comprising at least caller identification information,
a database for storing at least said caller identification information from said input, and
a data provision unit, associated with said database for forwarding said caller identification information to a called party.

27. Apparatus according to claim 26, wherein said call data further comprises a call type indicator for identifying a respective call as a video call.

28. Apparatus according to claim 26, wherein said data provision unit is operable for sending said caller identification information as an MMS.

29. Apparatus according to claim 26, wherein said database is associated with an aggregation unit comprising:
a comparator for comparing current caller identification information with caller identification information stored in said database, and
an aggregator, associated with said comparator, for aggregating together said current caller identification information with stored caller identification information identified by said comparator, thereby to output said current and said stored caller identification information as a single item.

30. Apparatus according to claim 26, wherein said database is associated with an aggregation unit comprising:
a comparator for comparing current caller identification information with caller identification information stored in said database, and
an aggregator, associated with said comparator, for storing said current caller identification information together with stored caller identification information identified by said comparator.

31. Apparatus according to claim 29, wherein said storing together comprises incrementing a number of times called field associated with said already stored caller identification information in said database.

32. Apparatus according to claim 29, wherein said database is structured such that said caller identification information is storable in said database together with a time of a respective video call, and wherein said storing together comprises replacing a time associated with said already stored caller identification information with a time of said current call.

33. Apparatus according to claim 26, further comprising an incomplete call detection module associated with said input, for detecting termination of a video call without said call being completed by said called party answering said call, wherein said incomplete call detection module is operable to trigger said database to process received call data of an incomplete video call as missed call data.

34. Apparatus according to claim 26, further comprising a slam-down detection module associated with said input, for detecting termination of a video call forwarded to a video mail system without a message being recorded for said called party, said slam-down module operable for triggering said database to process received call data of an incomplete video call as missed call data.

35. Apparatus according to claim 26, wherein said input is operable, via a protocol shared with a telephone network switch, to receive call data whenever said switch detects that a video call is released by a calling party without being completed by answering at said called party.

36. Apparatus according to claim 26, wherein said input is operable via a protocol shared with said video mail system to receive call data whenever said video mail system detects that a video call is released by a calling party without a message being recorded for said called party.

37. A method of providing sources of incomplete video calls comprising:
setting at least one of a network exchange switch and a video mail system with a protocol for sending caller identification information of video calls made through said switch but not completed, said caller identification information being indicative of said source,
receiving said caller identification information at a notification platform on said network, and
forwarding said caller identification information to the called party.

38. A method of providing sources of incomplete video calls comprising:
setting at least one of a network exchange switch and a video mail system to provide a notification platform with a signal that a call has been placed through said switch,
receiving said signal at a notification platform on said network,
identifying said call as an incomplete video call;
obtaining call data in response to said identification, said call data being at least indicative of a respective source, and
forwarding data indicative of said source to the called party.

39. A method according to claim 38, wherein said obtaining comprises querying said switch to provide stored call data.

40. A method according to claim 38, wherein said obtaining comprises extracting said call data from an ISUP IAM message.

41. Incomplete call notification method comprising:
detecting an incomplete video call,
obtaining call data of said incomplete video call, said video call being to a given called party and said call data being at least indicative of a calling party, and
arranging said called data into a format for forwarding to said called party.

42. Incomplete call notification method according to claim 41, wherein said called data is arranged as an MMS message.

43. Incomplete call notification method according to claim 42, wherein said MMS message includes a frame of said video call.

44. Incomplete call notification method according to claim 42, wherein said MMS message includes a graphic image.
